(19) United States
(12) Patent Application Publication
(10) Pub. No.: US 2010/0091742 A1
(43) Pub. Date: Apr. 15, 2010

(54) CORRELATION METHOD AND APPARATUS FOR ACQUIRING SYNCHRONIZATION IN WIRELESS LOCAL AREA NETWORK

(75) Inventors: Sang Yub Lee, Gyunggi-Do (KR); Chang Soo Yang, Gyunggi-Do (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electronics Co., Ltd., Suwon (KR)

(21) Appl. No.: 12/468,324

(22) Filed: May 19, 2009

(30) Foreign Application Priority Data
Oct. 10, 2008 (KR) 10-2008-0099741

(51) Int. Cl. H04J 3/06

(52) U.S. Cl. 370/336

(57) ABSTRACT

Provides is a correlation method for acquiring a synchronization in a wireless local area network (WLAN). In the correlation method, an auto-correlation value is measured in a receive (RX) signal based on the WLAN standard by use of a successive partial short preambles. A time point when the auto-correlation value becomes smaller than a predetermined threshold value is detected. A cross-correlation value for the successive partial short preambles is measured from the time point when the auto-correlation value becomes smaller than the predetermined threshold value. A time point when the cross-correlation value becomes maximum is determined as a reference time point for synchronization acquisition.

### CROSS-REFERENCE TO RELATED APPLICATIONS

This application claims the priority of Korean Patent Application No. 2008-0099741 filed on Oct. 10, 2008, in the Korean Intellectual Property Office, the disclosure of which is incorporated herein by reference.

### BACKGROUND OF THE INVENTION

1. Field of the Invention

The present invention relates to a correlation method and apparatus for rapid synchronization acquisition in a wireless local area network (WLAN), and more particularly, to a correlation method and apparatus for rapid synchronization acquisition in a WLAN, which can implement rapid and accurate synchronization timing detection by using partial short preambles constituting a WLAN frame.

2. Description of the Related Art

The number of the technical fields employing high-rate data communication using a wireless local area network (WLAN) has increased recently. Currently, the WLAN is being developed in accordance with various standards of IEEE 802.11 according to communication schemes and frequency bands used. Particularly, IEEE 802.11a, 802.11b and 802.11g have been standardized adopting an orthogonal frequency division multiplexing (OFDM) scheme, and IEEE 802.11n has been standardized to Draft 3.0.

A related art synchronization acquisition method applied to the WLAN system uses a short preamble and a long preamble contained in a WLAN packet structure. A related art IEEE 802.11a single-input single-output (SISO) OFDM scheme transmits/receives wireless signals through a single antenna and has a small channel distortion in an indoor environment, so that it does not require much effort for synchronization acquisition. Thus, a related art SISO communication scheme acquires a synchronization by using a correlation technique based on conventional auto-correlation characteristics and a correlation technique based on the cross-correlation between a receive (RX) signal and a transmit (TX) signal.

However, in a multi-input multi-output (MIMO) OFDM communication system for transmission/reception of a large amount of data, an interference between multiple antennas and an interference between channel signals become severe, thus affecting synchronization acquisition greatly. Particularly, symbol timing detection is susceptible to a channel distortion. If there is an error in the symbol timing detection, a window of fast Fourier transform (FFT) used in the OFDM scheme may be erroneously applied to cause an error in all symbols.

### SUMMARY OF THE INVENTION

An aspect of the present invention provides a correlation method and apparatus that can implement rapid and accurate synchronization acquisition in a wireless local area network (WLAN) by using a small amount of calculation.

According to an aspect of the present invention, there is provided a correlation method for acquiring a synchronization in a wireless local area network (WLAN), including: measuring an auto-correlation value in a receive (RX) signal based on the WLAN standard by use of a successive partial short preambles; detecting a time point when the auto-correlation value becomes smaller than a predetermined threshold value; measuring a cross-correlation value for the successive partial short preambles from the time point when the auto-correlation value becomes smaller than the predetermined threshold value; and determining a time point when the cross-correlation value becomes maximum as a reference time point for synchronization acquisition.

Herein, the successive partial short preambles may be the eight to tenth short preambles among ten successive short preambles contained in a WLAN packet in the RX signal. Among the successive partial short preambles, the short preambles used to measure the auto-correlation value may be the eighth and ninth short preambles, and the short preambles used to measure the cross-correlation value may be the ninth and tenth short preambles.

The correlation method may further include: detecting a current channel environment if there is no time point when the auto-correlation value becomes smaller than the predetermined threshold value; if the current channel environment is detected to be good, determining the time point for synchronization acquisition by using measured the auto-correlation value; and if the current channel environment is detected to be poor, correcting the predetermined threshold value and remeasuring the auto-correlation value.

According to another aspect of the present invention, there is provided a correlation apparatus for acquiring a synchronization in a wireless local area network (WLAN), including: an auto-correlation unit measuring an auto-correlation value in a receive (RX) signal based on the WLAN standard by use of successive partial short preambles, and detecting a time point when the auto-correlation value becomes smaller than a predetermined threshold value; and a cross-correlation unit measuring a cross-correlation value for the successive partial short preambles from the time point when the auto-correlation value becomes smaller than the predetermined threshold value, and determining a time point when the cross-correlation value becomes maximum as a reference time point for synchronization acquisition.

The auto-correlation unit may include; a delay unit delaying the RX signal by sequences contained in the successive partial short preambles; a conjugation unit calculating a conjugate complex number of the delayed signal; a multiplication unit multiplying the conjugate complex number of the delayed signal by the non-delayed RX signal; a summing unit summing the output results of the multiplication unit cumulatively by the number of the sequences contained in the successive partial short preambles to generate an auto-correlation value; and an auto-correlation result determining unit comparing the auto-correlation value and the predetermined threshold vale to detect the time point when the auto-correlation value becomes smaller than the predetermined threshold value.

The auto-correlation result determining unit may detect a current channel environment if there is no time point when the auto-correlation value becomes smaller than the predetermined threshold value, determine the time point for synchronization acquisition by using the measured auto-correlation value if the current channel environment is detected to be good, and correct the predetermined threshold value and remeasures the auto-correlation value if the current channel environment is detected to be poor.

The cross-correlation unit may include: a preamble storing unit prestoring the successive partial short preambles among the short preambles defined in the WLAN standard; a conjugation unit calculating a conjugate complex number of sequences of the short preamble stored in the preamble storing unit; a delay unit delaying the RX signal by the sequences contained in the successive partial short preambles from the time point when the auto-correlation value becomes smaller than the predetermined threshold value; a cross-correlation calculating unit multiplying the delayed signal by the conjugate complex number of the sequences of the short preamble stored in the preamble storing unit, and summing the multiplication results cumulatively by the number of the sequences contained in the successive partial short preambles to generate a cross-correlation value; and a cross-correlation result determining unit determining a time point when the cross-correlation value becomes maximum as a reference time point for synchronization acquisition.

Herein, the successive partial short preambles may be the eight to tenth short preambles among ten successive short preambles contained in a WLAN packet in the RX signal. Among the successive partial short preambles, the short preambles used to measure the auto-correlation value may be the eighth and ninth short preambles, and the short preambles used to measure the cross-correlation value may be the ninth and tenth short preambles.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart illustrating a correlation method for implementing rapid synchronization acquisition in a wireless local area network (WLAN) according to an exemplary embodiment of the present invention;

FIG. 2 is a diagram illustrating a packet structure according to the WLAN standard used in the present invention;

FIG. 3 is a block diagram of a correlation apparatus for implementing rapid synchronization acquisition in a WLAN according to an exemplary embodiment of the present invention;

FIGS. 4A and 4B are graphs illustrating the comparison of an auto-correlation value and a cross-correlation value that are calculated under various channel environments;

FIGS. 5A and 5B are graphs illustrating the relationship between a mean square error (MSE) and a channel state (SNR) varying with symbol timing offset (STO) conditions; and

FIGS. 6A and 6B are graphs illustrating the detection of a cross-correlation value and an auto-correlation value according to the length of a delay spread.

### DETAILED DESCRIPTION OF THE PREFERRED EMBODIMENT

Exemplary embodiments of the present invention will now be described in detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. In the drawings, the shapes and dimensions of elements are exaggerated for clarity of illustration.

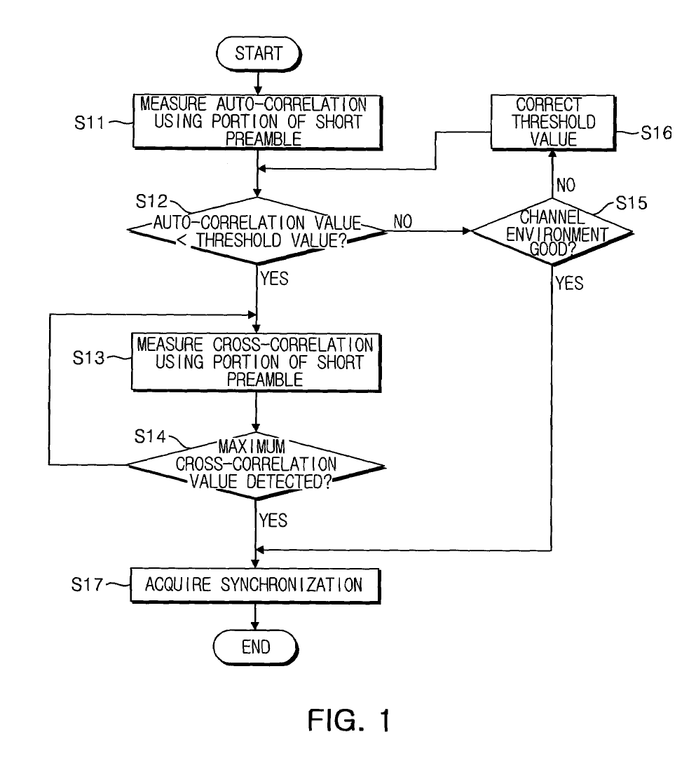

FIG. 1 is a flow chart illustrating a correlation method for implementing rapid synchronization acquisition in a wireless local area network (WLAN) according to an exemplary embodiment of the present invention.

Referring to FIG. 1, a correlation method for implementing rapid synchronization acquisition in a WLAN according to an exemplary embodiment of the present invention may include: measuring an auto-correlation value in a receive (RX) signal based on the WLAN standard by use of successive partial short preambles (S11); detecting a time point when the auto-correlation value becomes smaller than a predetermined threshold value (S12); measuring a cross-correlation value for the successive partial short preambles from the time point when the auto-correlation value becomes smaller than the predetermined threshold value (S13); detecting a time point when the cross-correlation value becomes maximum (S14); and determining the time point when the cross-correlation value becomes maximum as a reference time point for synchronization acquisition (S17).

In addition, the correlation method may further include: detecting a current channel environment if there is no time point when the auto-correlation value becomes smaller than the predetermined threshold value (S15). If the current channel environment is detected to be good, the correlation method determines the time point for synchronization acquisition by using the auto-correlation value measured in the auto-correlation value measuring step (S17). If the current channel environment is detected to be poor, the correlation method corrects the predetermined threshold value (S16) and again compares the auto-correlation value and the corrected threshold value (S12).

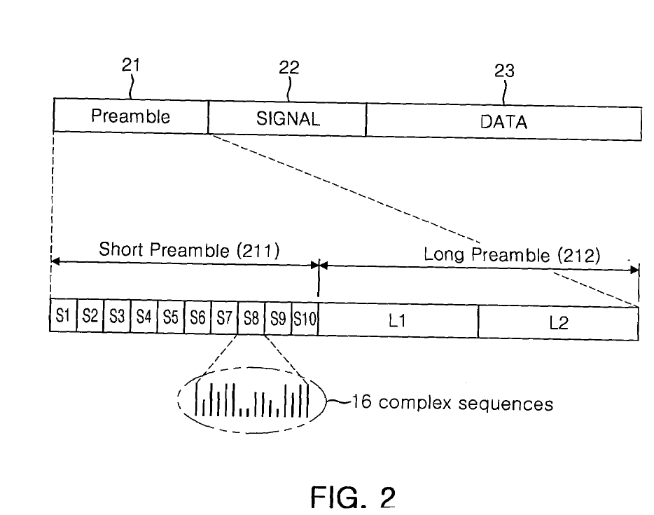

FIG. 2 is a diagram illustrating a packet structure according to the WLAN standard used in the present invention.

Referring to FIG. 2, a packet structure defined in the WLAN standard includes a preamble field 21, a signal field 22, and a data field 23. The preamble field 21 includes a short preamble section 211 and a long preamble section 212. The short preamble section 211 includes ten short preambles S1 to S10 for signal detection, automatic gain control, synchronization acquisition, and frequency shift control. The long preamble section 212 includes two long preambles L1 and L2 for channel control and fine frequency shift control. The signal field has information about a data length and a data rate of a transmitted frame. The data field has actual data information to be transmitted.

Each of the short preambles S1 to S10 has sixteen complex sequences. It is preferable that the present invention is applied to the eighth to tenth short preambles S8 to S10 among the ten short preambles S1 to S10, which are recommended to be used for timing synchronization. Specifically, it is preferable that the auto-correlation value measuring step (S11) is applied to the eighth and ninth short preambles S8 and S9, and it is preferable that the cross-correlation value measuring step (S13) is applied to the ninth and tenth short preambles S9 and S10.

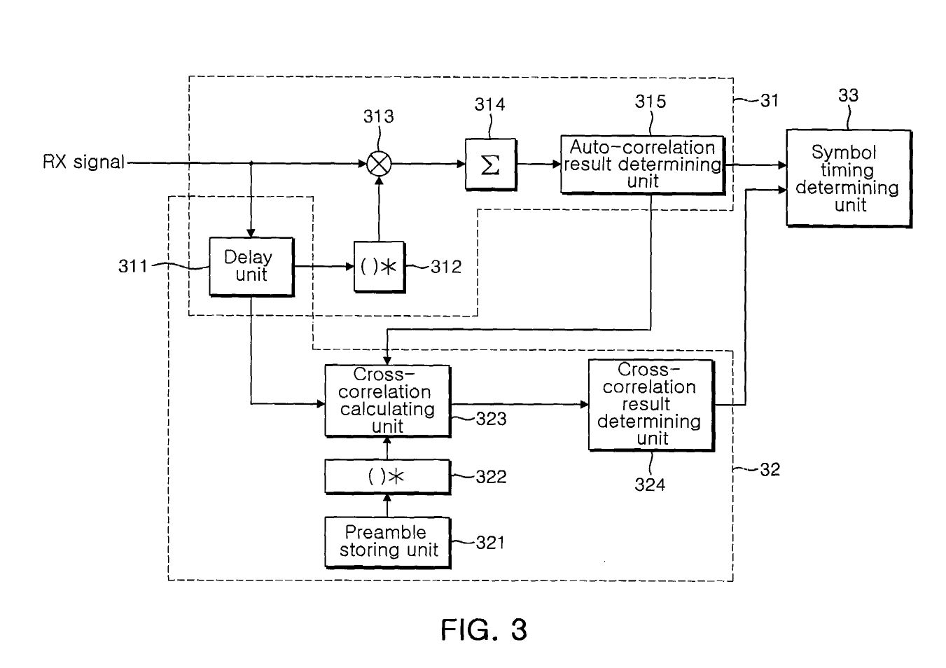

FIG. 3 is a block diagram of a correlation apparatus for implementing rapid synchronization acquisition in a WLAN according to an exemplary embodiment of the present invention.

Referring to FIG. 3, a correlation apparatus according to an exemplary embodiment of the present invention may include an auto-correlation unit 31 and a cross-correlation unit 32.

The auto-correlation unit 31 measures an auto-correlation value in a receive (RX) signal based on the WLAN standard by use of successive partial short preambles, and detects a time point when the auto-correlation value becomes smaller than a predetermined threshold value.

The cross-correlation unit 32 measures a cross-correlation value for the successive partial short preambles from the time point when the auto-correlation value becomes smaller than the predetermined threshold value, and determines a time point when the cross-correlation value becomes maximum as a reference time point for synchronization acquisition.

Specifically, the auto-correlation unit 31 may include: a delay unit 311 delaying an RX signal based on the WLAN standard by sequences contained in successive partial short preambles; a conjugation unit 312 calculating a conjugate complex number of the signal delayed by the delay unit 311; a multiplication unit 313 multiplying the conjugate complex number of the delayed signal by the non-delayed RX signal; a summing unit 314 summing the output results of the multiplication unit 312 cumulatively by the number of the sequences contained in the successive partial short preambles to generate an auto-correlation value; and an auto-correlation result determining unit 315 comparing the predetermined threshold vale and the auto-correlation value generated by the summing unit 314 to detect the time point when the auto-correlation value becomes smaller than the predetermined threshold value.

Specifically, the auto-correlation result determining unit 315 detects a current channel environment if there is no time point when the auto-correlation value becomes smaller than the predetermined threshold value. If the current channel environment is detected to be good, the auto-correlation result determining unit 315 determines the time point for synchronization acquisition by using the measured auto-correlation value. If the current channel environment is detected to be poor, the auto-correlation result determining unit 315 corrects the predetermined threshold value and remeasures the auto-correlation value.

The cross-correlation unit 32 may include: a preamble storing unit 321 prestoring the successive partial short preambles among the short preambles defined in the WLAN standard; a conjugation unit 322 calculating a conjugate complex number of sequences of the short preamble stored in the preamble storing unit 321; the delay unit 311 delaying the RX signal by the sequences contained in the successive partial short preambles from the time point when the auto-correlation value becomes smaller than the predetermined threshold value; a cross-correlation calculating unit 323 multiplying the delayed signal by the conjugate complex number of the sequences of the short preamble stored in the preamble storing unit 321, and summing the multiplication results cumulatively by the number of the sequences contained in the successive partial short preambles to generate a cross-correlation value; and a cross-correlation result determining unit 324 determining a time point when the cross-correlation value becomes maximum as a reference time point for synchronization acquisition.

The reference time point for synchronization acquisition, determined by the auto-correlation result determining unit 315 or the cross-correlation result determining unit 324, is provided to a symbol timing determining unit 33, so that symbol timing for an inputted RX signal can be determined through various additional calculations.

The circuit structure including the auto-correlation unit 31, the cross-correlation unit 32 and the symbol timing determining unit 33, illustrated in FIG. 3, may be provided in each of a plurality of RX antennas of a multi-input multi-output (MIMO) system. The determined symbol timings for the respective RX antennas may be combined by a symbol timing selecting unit (not illustrated) to detect the synchronization between the respective antenna channels. The symbol timing selecting unit may compare the detected symbol timings for the respective antenna channels, select the channel capable of implementing the optimum performance, and provide the same to a fast Fourier transform (FFT) unit.

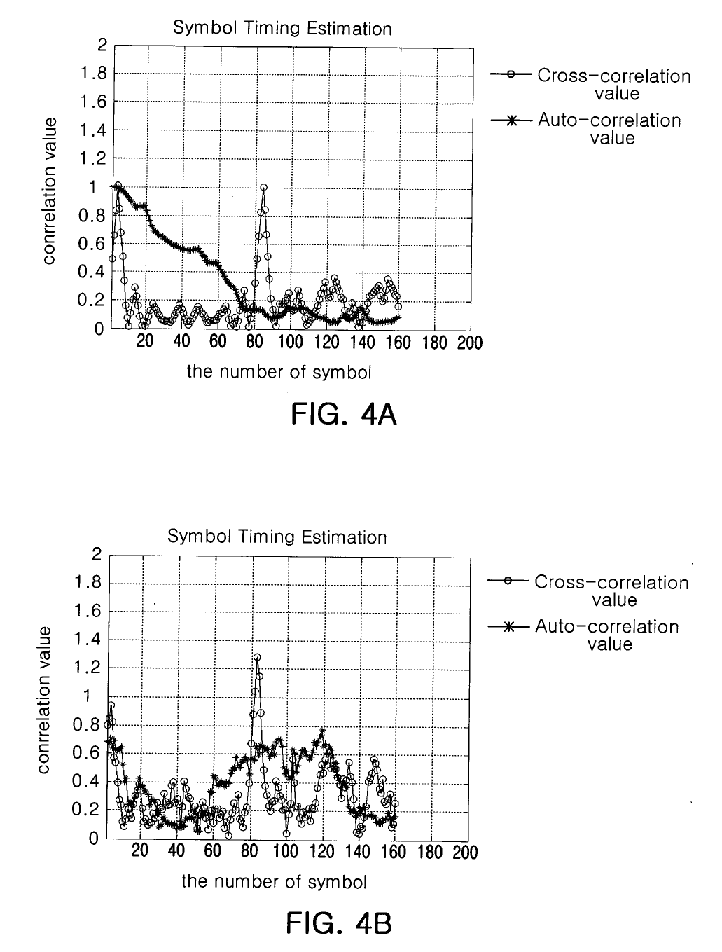

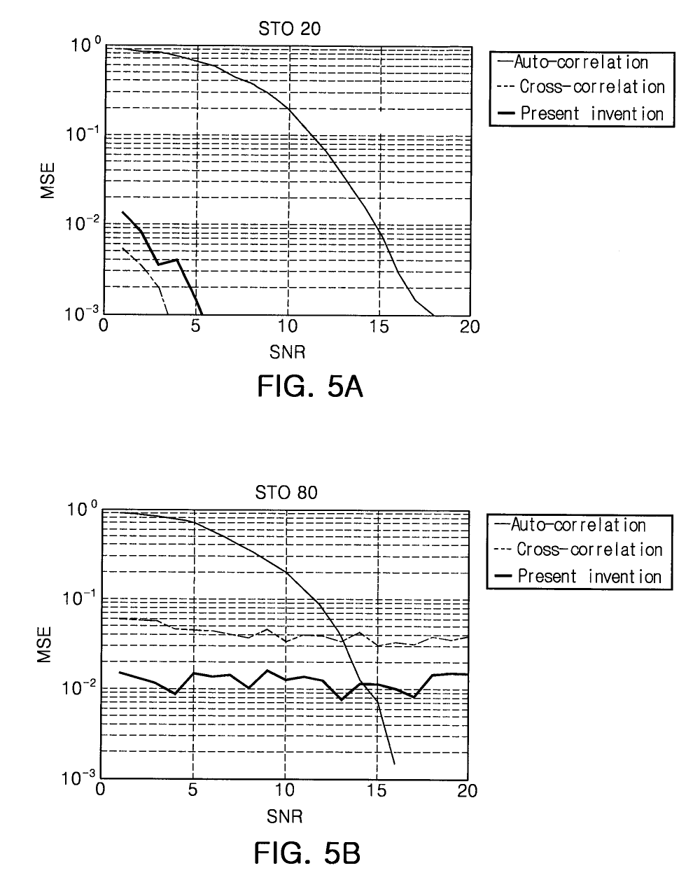

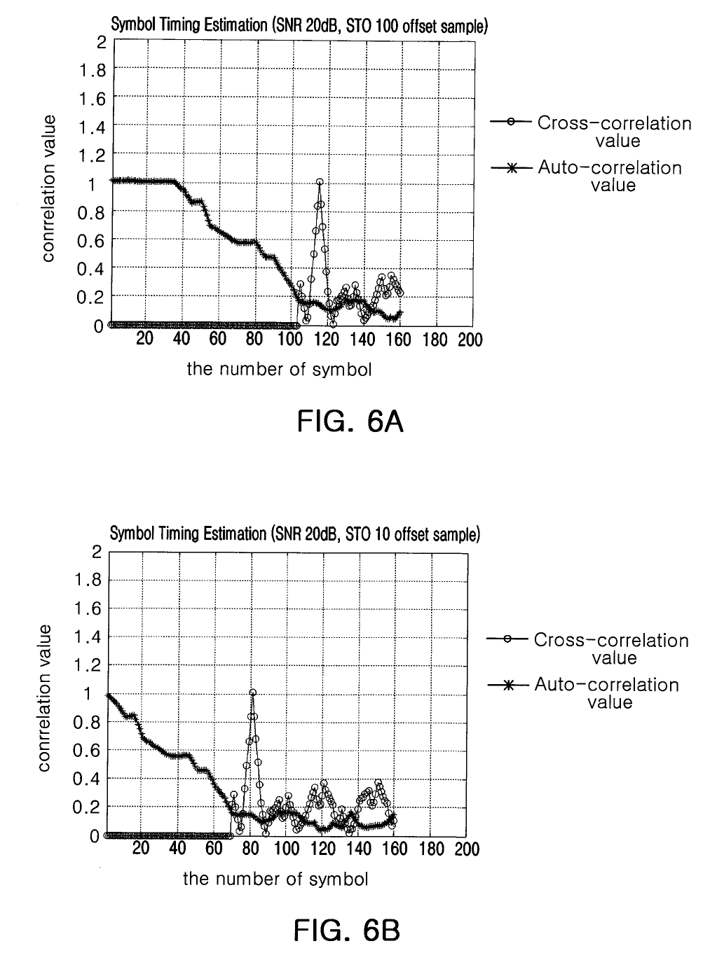

FIGS. 4A and 4B are graphs illustrating the comparison of an auto-correlation value and a cross-correlation value that are calculated under various channel environments. FIGS. 5A and 5B are graphs illustrating the relationship between a mean square error (MSE) and a channel state (SNR) varying with symbol timing offset (STO) conditions. FIGS. 6A and 6B are graphs illustrating the detection of a cross-correlation value and an auto-correlation value according to the length of a delay spread.

Hereinafter, the operation and effect of the present invention will be described in detail with reference to the accompanying drawings.

Referring to FIGS. 1 to 3, an inputted WLAN RX signal is first inputted to the auto-correlation unit 31. The auto-correlation unit 31 measures an auto-correlation value by performing an auto-correlation operation on the eighth and ninth short preambles S8 and S9 among the ten short preambles S1 to S10 contained in the inputted WLAN RX signal (S1). The auto-correlation operation may be performed by the delay unit 311, the conjugation unit 312, the multiplication unit 313, and the summing unit 314. For example, the delay unit 311 delays the RX signal by the sequences contained in the eighth and ninth short preambles S8 and S9. Thereafter, the conjugation unit 312 calculates the conjugate complex number of the signal delayed by the delay unit 311. Thereafter, the multiplication unit 313 multiplies the conjugate complex number of the delayed signal by the non-delayed RX signal. Thereafter, the summing unit 314 sums the output results of the multiplication unit 313 cumulatively by the number of the sequences contained in the successive partial short preambles to generate an auto-correlation value.

Thereafter, the auto-correlation result determining unit 315 compares the predetermined threshold value and the auto-correlation value generated by the summing unit 314 to detect the time point when the auto-correlation value becomes smaller than the predetermined threshold value (S12).

If the auto-correlation result determining unit 315 fails to detect the time point when the auto-correlation value becomes smaller than the predetermined threshold value, the auto-correlation result determining unit 315 detects a current channel environment, for example, a signal-to-noise ratio (SNR) (S15). If the current channel environment is detected to be good, the auto-correlation result determining unit 315 determines that synchronization acquisition can be performed by only auto-correlation, sets a time point when the auto-correlation value becomes greater than another predetermined threshold value as a reference time point for synchronization acquisition, and provides the same to the symbol timing determining unit 33. If the current channel environment is detected to be poor, the threshold value is corrected to recalculate a cross-correlation start point by an auto-correlation value (S16). The corrected threshold value is used to redetermine a time point when the detected auto-correlation value becomes smaller than the threshold value (S12).

If the auto-correlation result determining unit 315 detects the time point when the auto-correlation value becomes smaller than the predetermined threshold value, the cross-correlation unit 32 starts to calculate a cross-correlation value from the detected time point (S13).

Specifically, the conjugation unit 322 calculates the conjugate complex number of the sequences of the ninth and tenth short preambles S9 and S10 based on the WLAN standard and stored in the preamble storing unit 321 of the cross-correlation unit 32. The delay unit 311 delays the ninth and tenth short preambles S9 and S10 contained in the RX signal by the number of the sequences contained in the two short preamble sequences. Thereafter, the cross-correlation calculating unit 323 multiplies the delayed signal of the delay unit 311 by the conjugate complex number of the sequences of the short preamble stored in the preamble storing unit 321, and sums the multiplication results cumulatively by the number of the sequences contained in the successive partial short preambles to generate a cross-correlation value. Thereafter, the cross-correlation result determining unit 324 determines a time point when the cross-correlation value becomes maximum as a reference time point for synchronization acquisition (S14), and provides the same to the symbol timing determining unit 33.

FIGS. 4A and 4B are graphs illustrating the comparison of an auto-correlation value and a cross-correlation value that are calculated under various channel environments.

As described above, the exemplary embodiment of the present invention uses the eight to tenth short preambles S8 to S10 among the ten short preambles S1 to S10. In this manner, the present invention uses such a very short preamble section to obtain the total symbol timing. To this end, the present invention performs an auto-correlation operation on the eight and ninth preambles S8 and S9 to determine the suitableness of synchronization acquisition, and performs a cross-correlation operation on the ninth and tenth preambles S9 and S10 to detect an accurate symbol timing.

In this way, the two correlation operations including the auto-correlation operation and the cross-correlation operation are performed on the eighth to tenth short preambles S8 to S10 to measure and correct the total symbol timing in the short preamble section. Particularly, the timing synchronization detected through the auto-correlation operation performed in the eighth and ninth short preambles S8 and S9 makes it possible to determine the time point to start a suitable correction. In other words, the cross-correlation operation performed in the ninth and tenth short preambles S9 and S10 uses the signal detection position detected through the auto-correlation operation in the previous section to change the auto-correlation start position of the foreknown short preamble used in the cross-correlation, thereby making it possible to obtain a more accurate cross-correlation value. This can be more clearly understood with reference to FIG. 4.

In case of using only a cross-correlation value, as illustrated in FIG. 4A, the cross-correlation maximum value is repeated by a short preamble foreknown by a receiving terminal. If a long preamble is not used because of repetition of the maximum value, it is impossible to detect an accurate timing synchronization position. FIG. 4A illustrates the case of the maximum value being generated repetitively, and FIG. 4B illustrates the case of failing to detect the repeated point due to the channel influence.

In general, there are two factors that cause an synchronization error. One of the factors is the case where a signal and a noise are not discriminated because a signal-to-noise ration (SNR) of the current channel is not good. In this case, a delay spread generated in the channel also increases and a packet to be detected is delayed, so that the synchronization point fails to be detected. Thus, the present invention uses an auto-correlation technique in a short preamble section to detect a synchronization correction portion for use in cross-correlation, and uses cross-correlation in the detected correction portion to acquire accurate synchronization. The use of two correlation techniques in the short section makes it possible to detect a synchronization point and reduce a performance distortion due to an inter-antennal interference and a channel interference in a multi-input multi-output (MIMO) orthogonal frequency division multiplexing (OFDM) system.

As described above, the present invention uses the auto-correlation illustrated in FIG. 4 in the eighth and ninth short preambles S8 and S9 to detect a detectable point (e.g., the point when an auto-correlation value becomes smaller than 0.2), and uses the cross-correlation from the detectable point to detect the repeated point. Herein, the cross-correlation maximum value occurs once after the auto-correlation.

FIGS. 5A and 5B are graphs illustrating the relationship between a mean square error (MSE) and a channel state (SNR) varying with symbol timing offset (STO) conditions.

Referring to the result of FIG. 5, the performance is analyzed in consideration of STO effects according to channel conditions. As illustrated in FIG. 5A, using only a cross-correlation technique is advantageous in a small STO environment. As illustrated in FIG. 5B, an auto-correlation technique is advantageous in a large STO environment although the channel condition is good. Therefore, it is necessary to use the structure that detects the STO condition and the current channel condition in the eighth and ninth short preambles S8 and S9 through the auto-correlation and then uses a synchronization scheme adaptively by using the cross-correlation. The correlation technique used in the present invention does not need a delay buffer and a data buffer, and has only to have a short preamble at a receiving terminal. Therefore, the present invention need not use a long preamble, thus making it possible to reduce the corresponding delay.

FIGS. 6A and 6B are graphs illustrating the detection of a cross-correlation value and an auto-correlation value according to the length of a delay spread.

As described above, the present invention uses the auto-correlation value to estimate a portion for synchronization correction, and then uses the cross-correlation value to acquire an accurate synchronization. FIG. 6A illustrates synchronization acquisition for a channel condition of a long delay spread, and FIG. 6B illustrates synchronization acquisition for a channel condition of a short delay spread. As illustrated in FIG. 6, the present invention uses the auto-correlation value to estimate a portion for synchronization correction and then uses the cross-correlation value to perform synchronization acquisition, thus making it possible to implement an accurate synchronization acquisition regardless of the length of a delay spread.

As described above, the present invention can implement the synchronization acquisition in a WLAN system by using only a portion of the short preamble. Particularly, the present invention uses the auto-correlation for the short preamble to detect the channel state, and then uses the cross-correlation. The use of both the cross-correlation and the auto-correlation makes it possible to adapt to a channel condition and an inter-antenna interference in the MIMO OFDM system and implement a more accurate synchronization acquisition. Also, the present invention reduces the synchronization acquisition time to thereby detect the optimum synchronization point for each path of the MIMO antenna in the preamble section, thus making it possible to improve the performance of the MIMO communication system.

While the present invention has been shown and described in connection with the exemplary embodiments, it will be apparent to those skilled in the art that modifications and variations can be made without departing from the spirit and scope of the invention as defined by the appended claims.

What is claimed is:

1. A correlation method for acquiring a synchronization in a wireless local area network (WLAN), comprising:
measuring an auto-correlation value in a receive (RX) signal based on the WLAN standard by use of a successive partial short preambles;
detecting a time point when the auto-correlation value becomes smaller than a predetermined threshold value;
measuring a cross-correlation value for the successive partial short preambles from the time point when the auto-correlation value becomes smaller than the predetermined threshold value; and
determining a time point when the cross-correlation value becomes maximum as a reference time point for synchronization acquisition.

2. The correlation method of claim 1, wherein the successive partial short preambles are the eight to tenth short preambles among ten successive short preambles contained in a WLAN packet in the RX signal.

3. The correlation method of claim 2, wherein among the successive partial short preambles, the short preambles used to measure the auto-correlation value are the eighth and ninth short preambles, and the short preambles used to measure the cross-correlation value are the ninth and tenth short preambles.

4. The correlation method of claim 1, further comprising:
detecting a current channel environment if there is no time point when the auto-correlation value becomes smaller than the predetermined threshold value;
if the current channel environment is detected to be good, determining the time point for synchronization acquisition by using measured the auto-correlation value; and
if the current channel environment is detected to be poor, correcting the predetermined threshold value and remeasuring the auto-correlation value.

5. A correlation apparatus for acquiring a synchronization in a wireless local area network (WLAN), comprising:
an auto-correlation unit measuring an auto-correlation value in a receive (RX) signal based on the WLAN standard by use of successive partial short preambles, and detecting a time point when the auto-correlation value becomes smaller than a predetermined threshold value; and
a cross-correlation unit measuring a cross-correlation value for the successive partial short preambles from the time point when the auto-correlation value becomes smaller than the predetermined threshold value, and determining a time point when the cross-correlation value becomes maximum as a reference time point for synchronization acquisition.

6. The correlation apparatus of claim 5, wherein the auto-correlation unit comprises;
a delay unit delaying the RX signal by sequences contained in the successive partial short preambles;
a conjugation unit calculating a conjugate complex number of the delayed signal;
a multiplication unit multiplying the conjugate complex number of the delayed signal by the non-delayed RX signal;
a summing unit summing the output results of the multiplication unit cumulatively by the number of the sequences contained in the successive partial short preambles to generate an auto-correlation value; and
an auto-correlation result determining unit comparing the auto-correlation value and the predetermined threshold vale to detect the time point when the auto-correlation value becomes smaller than the predetermined threshold value.

7. The correlation apparatus of claim 6, wherein the auto-correlation result determining unit detects a current channel environment if there is no time point when the auto-correlation value becomes smaller than the predetermined threshold value, determines the time point for synchronization acquisition by using the measured auto-correlation value if the current channel environment is detected to be good, and corrects the predetermined threshold value and remeasures the auto-correlation value if the current channel environment is detected to be poor.

8. The correlation apparatus of claim 5, wherein the cross-correlation unit comprises:
a preamble storing unit prestoring the successive partial short preambles among the short preambles defined in the WLAN standard;
a conjugation unit calculating a conjugate complex number of sequences of the short preamble stored in the preamble storing unit;
a delay unit delaying the RX signal by the sequences contained in the successive partial short preambles from the time point when the auto-correlation value becomes smaller than the predetermined threshold value;
a cross-correlation calculating unit multiplying the delayed signal by the conjugate complex number of the sequences of the short preamble stored in the preamble storing unit, and summing the multiplication results cumulatively by the number of the sequences contained in the successive partial short preambles to generate a cross-correlation value; and
a cross-correlation result determining unit determining a time point when the cross-correlation value becomes maximum as a reference time point for synchronization acquisition.

9. The correlation apparatus of claim 8, wherein the successive partial short preambles are the eight to tenth short preambles among ten successive short preambles contained in a WLAN packet in the RX signal.

10. The correlation apparatus of claim 9, wherein among the successive partial short preambles, the short preambles used to measure the auto-correlation value are the eighth and ninth short preambles, and the short preambles used to measure the cross-correlation value are the ninth and tenth short preambles.
